(19) United States
(12) Patent Application Publication
(10) Pub. No.: US 2023/0159355 A1
(43) Pub. Date: May 25, 2023

(54) COLLIMATION TYPE DISINFECTION AND WATER PURIFICATION DEVICE

(71) Applicant: FOSHAN UNIVERSITY, FOSHAN, GUANGDONG (CN)

(72) Inventors: BINGFENG FAN, FOSHAN, GUANGDONG (CN); ZEKAI HONG, FOSHAN, GUANGDONG (CN); RENKAI WU, FOSHAN, GUANGDONG (CN)

(21) Appl. No.: 17/638,310

(22) PCT Filed: Feb. 5, 2021
(86) PCT No.: PCT/CN2021/075418

§ 371 Date: Feb. 25, 2022

(30) Foreign Application Priority Data
Jan. 11, 2021 (CN) 202110028504.4

(51) Int. Cl. C02F 1/32

(52) U.S. Cl. CPC C02F 1/325; C02F 2201/3222; C02F 2201/3227; C02F 2201/3228; C02F 2303/04

(57) ABSTRACT

A collimation type disinfection and water purification device includes a reactor cavity. The reactor cavity is in a linear shape extending in a front side direction and a rear side direction. A water inlet and a water outlet are respectively formed in side walls of a front side and a rear side of the reactor cavity. Ultraviolet (UV) modules are arranged at end parts of the reactor cavity. The UV module includes a radiation component and a Total Internal Reflection (TIR) lens. The radiated UV light can enter the reactor cavity in a collimation manner by using a design that the radiation component is matched with the TIR lens, which improves the disinfection efficiency.

### TECHNICAL FIELD

The present disclosure relates to the technical field of water purification, and in particular, to a collimation type disinfection and water purification device, which is suitable for Ultraviolet (UV) disinfection type water purification.

### BACKGROUND ART

Water is an essential substance for the production and living of people, and the purification of water is becoming more and more important, so disinfection treatment on a water body is particularly important. After coagulation or filtration, microorganisms in the water body are greatly reduced, but are not completely inactivated. In the prior art, the following means are commonly used for the disinfection of domestic water: 1. physical methods, such as ultrasonic disinfection, a heating method, etc.; and 2. chemical methods: other oxidant methods, such as a chlorination method, ozone method and heavy metal ion method. However, the range of action of the heating method and the ultrasonic disinfection is limited, and the chemical substances in the chemical methods have negative effects on the environment, including water toxicity, the risk of organic chlorine, and the resistance of viruses and protists to chlorine. By comparison, the advantages that the effect is good and no disinfection by-product is produced of the UV disinfection type water purification, especially deep UV disinfection, have attracted people's attention.

Dynamic direct drinking water deep UV LED sterilizer with the publication number of CN104016443B discloses a dynamic direct drinking water deep UV LED sterilizer, including a water inlet component, a water outlet component, a disinfection and sterilization component, and a deep UV LED module. A deep UV LED serves as a light-emitting source, a point area irradiated by the deep UV LED module has high light intensity and no poisonous substance, and efficient disinfection and sterilization of dynamic water are realized. UV LED fluid disinfection system with the publication number of CN103570098A discloses an efficient fluid disinfection treatment system integrated with a deep UV LED chip. In view of the disadvantages that UV spectrum radiation distribution is uneven and the effect of the deep UV LED chip is reduced, a deep UV LED component is adopted to produce UV light with an efficient disinfection function. The UV light can effectively pass through a transparent pipeline to disinfect a fluid in the pipeline, and a light reflecting material with an anti-UV function is coated on an inner surface and an outer surface of the pipeline, thus, the UV light is reflected back in the pipeline and the UV light is emitted and transmitted by the deep UV LED in the pipeline. Flowing fluid disinfection method and sterilizer with the publication number of CN109395118A discloses a flowing fluid disinfection method using deep UV rays and a disinfector for realizing flowing fluid disinfection. In view of the disadvantage that a current fluid disinfection technology will suffer UV energy loss due to a solid-liquid surface between a fluid to be disinfected and a device containing the fluid, a flowing fluid column with a side wall that is wrapped by a fluid medium and is in contact with the fluid medium, and the UV light is emitted into the flowing fluid column in the axial direction, so that the UV energy loss is reduced, the disinfection effect of the flowing fluid, such as water, drink, or medical fluid, is improved.

However, it is found the practice that when a large amount of fluid is treated by using a UV water purification technology, there are still problems of low light energy utilization rate of a UV radiation source and coupling of a light field and a flow field in a disinfection process, which result in that the disinfection of the water body is incomplete and not thorough. In addition, the process of equipment is complex and the production cost of a device is high in the abovementioned prior art. In order to solve the abovementioned problems, it is urgent to propose a new technical means.

### SUMMARY

In order to overcome the disadvantages of the prior art, the present disclosure provides a collimation type disinfection and water purification device. Inactivation treatment on microorganisms in a water body is completed better by performing collimating optimization on the light emitted from a UV radiation source, which greatly improves the disinfection and sterilization effects.

A technical solution adopted to solve the technical problems thereof of the present disclosure is that: a collimation type disinfection and water purification device is provided, including a reactor cavity. The reactor cavity is in a linear shape extending in a front side direction and a rear side direction. A water inlet and a water outlet are respectively formed in side walls of a front side and a rear side of the reactor cavity. A UV module is arranged at an end part of the reactor cavity. The UV module includes a radiation component and a Total Internal Reflection (TIR) lens. The light emitted from the radiation component is projected as a uniform columnar collimating light source after passing through the TIR lens.

According to the collimation type disinfection and water purification device provided by the present disclosure, a design that the radiation component is matched with the TIR lens is adopted, so that the radiated UV light can be enter the reactor cavity in a collimation manner, which realizes the decoupling of the light field and the flow field, and improves the disinfection efficiency.

As some preferred embodiments of the present disclosure, the radiation component includes a deep UVC-LED with the wave band of 200 to 320 nm.

As some preferred embodiments of the present disclosure, the UV module includes a UV module and a substrate.

As some preferred embodiments of the present disclosure, a mounting groove is formed in the substrate.

As some preferred embodiments of the present disclosure, the radiation component includes a radiation source substrate and radiating fins. A radiating fin alignment groove is formed in the mounting groove. The mounting groove corresponds to the radiation source substrate. The radiating fin alignment groove corresponds to the radiating fins.

As some preferred embodiments of the present disclosure, auxiliary radiating fins are arranged on the substrate.

As some preferred embodiments of the present disclosure, UV modules are arranged at a front end and a rear end of the reactor cavity.

As some preferred embodiments of the present disclosure, a UV module is arranged at one end of the reactor cavity, and a reflection component is arranged at the other end of the reactor cavity.

As some preferred embodiments of the present disclosure, a Polytetrafluoroethylene (PTFE) diffuse reflection coating is arranged on an inner wall of the reactor cavity.

As some preferred embodiments of the present disclosure, a quartz tube is arranged in the reactor cavity. The present disclosure has the following beneficial effects.

1. The technology is suitable for performing sterilization and disinfection with deep a UVC-LED. Compared with performing sterilization and disinfection by directly inserting a mercury lamp in the traditional art, the deep UVC-LED has a higher safety coefficient and higher sterilization and disinfection efficiency.

2. According to the technology, the radiation component is matched with the TIR lens to perform optimized collimation treatment on the radiated UV light. Compared with traditional direct light source irradiation, the technology has higher sterilization and disinfection radiation uniformity, so that more UV radiation light directly irradiates dynamic fluid low in the reactor cavity in a collimation manner.

3. According to the technology, the radiation component is matched with the TIR lens, the uniform and collimated light field is formed in the reactor cavity. Compared with forming a good disinfection and water purification space by coupling a flow field and a light field in the traditional art, the present disclosure realizes the decoupling of the flow field and the light field for the first time in deep UV water disinfection, and a traditional structure is simplified, so that the structure and principle of a TIR lens-collimated columnar deep UV LED disinfection and water purification device are simpler, and the cost is reduced.

4. A detachable expansion module and a deep UV disinfection and water purification module are adopted. Compared with integrally connecting a reaction treatment module in the traditional art, the flexibility is higher. Different module components can be adopted according to the dynamic fluid flow of different scale types, and meanwhile, a component replacement manner has a more flexible treatment manner compared with traditional integrated treatment when a module component is damaged.

5. According to the technology, closed dynamic fluid flow treatment is performed by using the quartz tube, the water inlet, and the water outlet in an area which is in direct contact with the dynamic fluid flow. Compared with traditional direct contact between the dynamic fluid flow and a coating material, the safety coefficient is higher.

### BRIEF DESCRIPTION OF THE DRAWINGS

The present disclosure is further described below with reference to accompanying drawings and embodiments.

FIG. 1 is a structural schematic diagram of the present disclosure;

FIG. 2 is a sectional view of the present disclosure;

FIG. 3 is a structural decomposition diagram of the present disclosure;

FIG. 4 is a structural schematic diagram of another implementation manner of the present disclosure;

FIG. 5 is a structural schematic diagram of an UV module of the present disclosure;

FIG. 6 is a structural schematic diagram of the UV module of the present disclosure;

FIG. 7 is a structural decomposition diagram of a substrate of the present disclosure;

FIG. 8 is a sectional view of the substrate of the present disclosure;

FIG. 9 is a spectrum diagram of a test light source;

FIG. 10 is an average irradiance map of double radiation sources with and without a TIR lens; and

FIG. 11 is a Relative Standard Deviation (RSD) diagram of the double radiation sources with and without the TIR lens.

### REFERENCE SIGNS IN THE DRAWINGS

Reactor cavity 100, water inlet 101, water outlet 102, quartz tube 110, UV module 200, radiation component 210, radiation source substrate 211, radiating fin 212, TIR lens 220, UV module sleeve 230, substrate 240, mounting groove 241, radiating fin alignment groove 242, auxiliary radiating fin 243, and reflection component 300.

### DETAILED DESCRIPTION OF THE EMBODIMENTS

In order to make the objective, technical solutions, and advantages of the present application clearer, the present disclosure is further described in detail below with reference to the accompanying drawings and implementation manners. In order to thoroughly understand the present disclosure, some specific details will be involved in the following description. In the absence of these specific details, the creation of the present disclosure can still be realized, that is, those skilled in the art can more effectively introduce their work essence to other technicians in the art by using these descriptions and statements here. In addition, it should be noted that the words “front side”, “rear side”, “upper side”, “lower side”, and the like used in the following description refer to the directions in the accompanying drawings, and the words “inside” and “outside” refer to the direction facing or away from a geometric center of a specific component respectively. Simple adjustment without creative inventiveness made by those skilled in a relevant art in the abovementioned directions shall not be understood as a technology beyond the scope of protection of the present application.

It should be understood that the specific implementation manners described here are merely used for explain the present application and are not intended to limit an actual scope of protection. In order to avoid confusing the objective of the present disclosure, the well-known technologies of a manufacturing method, a control program, part sizes, material compositions, pipeline layout, etc. have been easily understood, so they have not been described in detail.

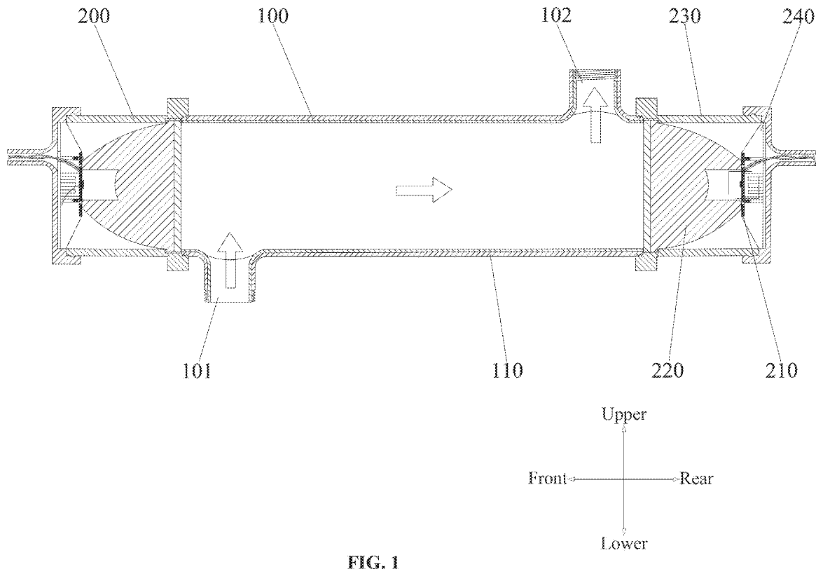

FIG. 1 is a structural schematic diagram of an implementation manner of the present disclosure. Referring to FIG. 1, an implementation manner of the present disclosure provides a collimation type disinfection and water purification device, including a reactor cavity 100. The reactor cavity 100 is in a linear shape extending in a front side direction and a rear side direction. A water inlet 101 and a water outlet 102 are respectively formed in side walls of a front side and a rear side of the reactor cavity 100. The reactor cavity 100 is of a relatively sealed structure. Water enters the reactor cavity 100 from the water inlet 101, and then flows out from the water outlet 102.

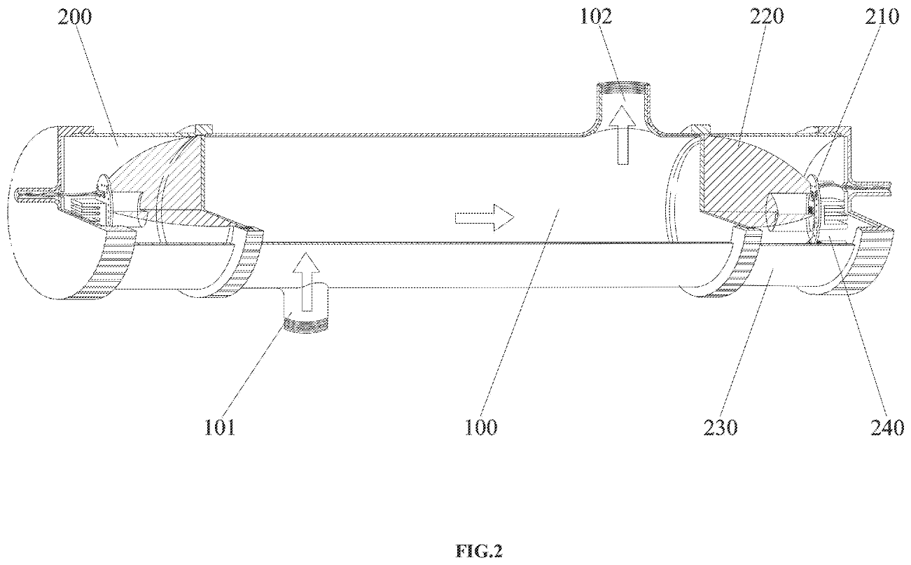

Further, referring to FIG. 2, a UV module 200 is arranged at an end part of the reactor cavity 100. The UV module 200 includes a radiation component 210 and a TIR lens 220. Operations of disinfection and purification are performed by the UV module 200 through the UV light emitted from the radiation component 210. A sterilization principle of the UV light is that molecular structures of deoxyribonucleic acid (DNA) and ribonucleic acid (RNA) of microorganisms will be damaged due to the absorption of the energy of the UV light when the microorganisms are irradiated by the UV light on the basis of the absorption of the UV light by the nucleic acid of the microorganisms, so as to result in the death of growth cells and regenerative cells. The microorganisms are inactivated to lose the functions of reproduction and self replication, so as to achieve the effects of sterilization and disinfection.

Further, the light emitted from the radiation component 210 is projected as a uniform columnar collimating light source after passing through the TIR lens 220. The TIR lens 220 is made according to a Fresnel lens principle. A specific structure and a working principle can refer to the existing TIR lens device, which will not be elaborated here.

During operation, the UV light emitted from the radiation component 210 is enters into the reactor cavity 100 in a collimation manner by the TIR lens 220 by using collimating and condensing characteristics thereof, so that decoupling of a light field and a flow field is realized. The disinfection and water purification device formed by matching the linear reactor cavity 100 achieves a good disinfection effect, is simpler and more efficient, and has higher uniformity compared with the traditional direct light source radiation light.

The disclosure of the collimation type disinfection and water purification device disclosed above is only a preferred embodiment of the present disclosure, which is merely used to explain the technical solution of the present disclosure and is not intended to limit the present disclosure. It should be appreciated by those of ordinary skill in the art that modifications and supplements may still be made to the technical solution recorded in the foregoing technical solution in combination with the prior art, or equivalent replacements may be made to some of the technical features. However, these modifications or replacements do not separate the essence of the corresponding technical solution from the spirit and scope of the technical solution of the embodiment of the present disclosure.

The following will be described in combination with some embodiments, in which the “embodiment” herein refers to a specific feature, structure or characteristic that can be included in at least one implementation manner of the present application. “In the embodiments” appearing in different places in this specification do not all refer to the same embodiment, nor are separate or selective embodiments mutually exclusive with other embodiments. In addition, the details of one or more embodiments are not intended to be a fixed reference to any particular order, and are not intended to limit the present disclosure.

Embodiment 1, the water inlet 101 is located on a lower side of a front side of the reactor cavity 100, and the water outlet 102 is located on an upper side of the front side of the reactor cavity 100.

Embodiment 2, the radiation component 210 includes a deep UVC-LED with the wave band of 200 to 320 nm. The deep UVC-LED serves as a cold light source, has high light-emitting radiation efficiency, and has higher electrical-to-optical conversion efficiency and lower electrical-thermal conversion. For example, a single chip (0.125 mm²) can produce UVC radiation power of about 10 mw at 20 mA.

In the present embodiment, optionally, a radiation source of the radiation component 210 adopts a plurality of chips that are integrated to perform radiation disinfection, so that it can produce higher radiation power in a small volume, and has extremely significant advantages than disinfecting by using a traditional mercury lamp with a large volume and a fixed shape.

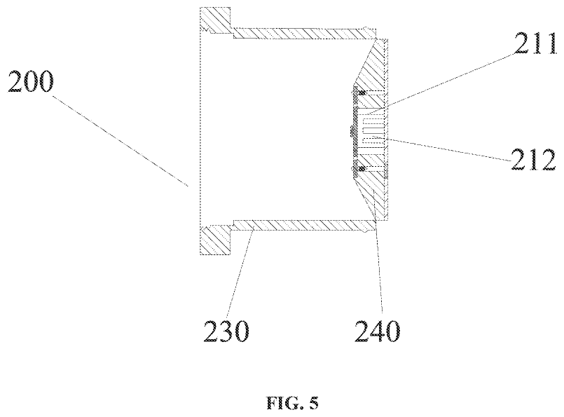

In the present embodiment, referring to FIG. 5, optionally, the radiation component 210 includes a radiation source substrate 211, and the deep UVC-LED is distributed on the radiation source substrate 211 as a radiation source.

In the present embodiment, optionally, the range of the wave band of the deep UVC-LED is 240 to 280 nm. In the present embodiment, optionally, the radiation component 210 includes radiating fins 212. The material of the radiating fins 212 may be selected from a heat conducting metal (such as Aluminum (Al) or Copper (Cu)). The distribution manner of the radiating fins 212 and the concave-convex surface shape of radiating fins 212 are changed to increase the surface area of the radiating fins 212, and the radiating efficiency is improved.

Embodiment 3, the UV module 200 includes an UV module sleeve 230 and a substrate 240.

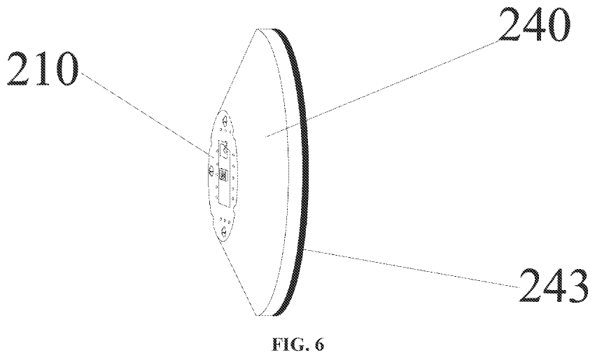

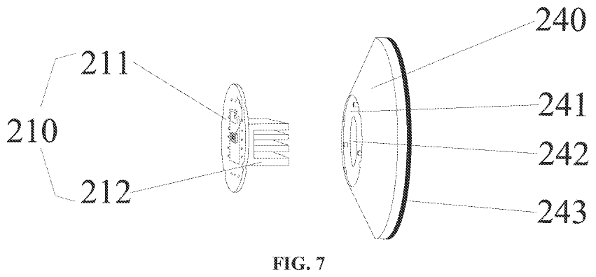

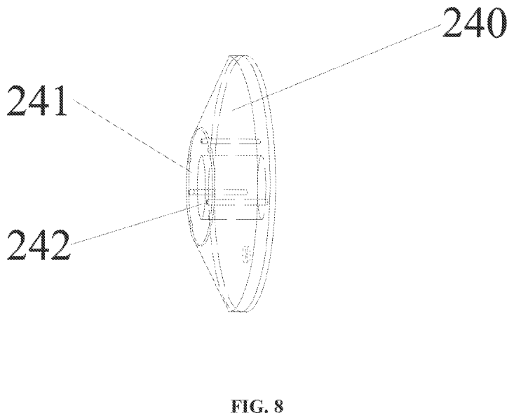

Embodiment 4, referring to FIG. 6, FIG. 7, and FIG. 8, a mounting groove 241 is formed in the substrate 240, and is used to fix the radiation component 210.

Embodiment 5, the radiation component 210 includes a radiation source substrate 211 and a radiating fins 212. Radiation sources are distributed on the radiation source substrate 211. The radiating fins 212 ensure the radiating of the radiation source substrate 211 during the operation of the radiation sources.

A radiating fin alignment groove 242 is formed in the mounting groove 241, the mounting groove 241 corresponds to the radiation source substrate 211, and the radiating fin alignment groove 242 corresponds to the radiating fins 212. The mechanical strength and the airtightness of the connection and fixation of the radiation source substrate 211 in press fit are enhanced.

In the present embodiment, optionally, a manner of forming the mounting groove 241 and the radiating fin alignment groove 242 includes, but is not limited to, lathe milling, Three-Dimensional (3D) printing molding, and casting.

In the present embodiment, optionally, the mounting groove 241 and the radiating fin alignment groove 242 are formed in a casting manner.

Embodiment 6, auxiliary radiating fins 243 are arranged on the substrate 240. During operation, the produced heat is from the radiation source substrate 211 to the radiating fins 212, then is from the radiating fins 212 to the auxiliary radiating fins 243, and finally is transferred and diffused outwards through air or other media.

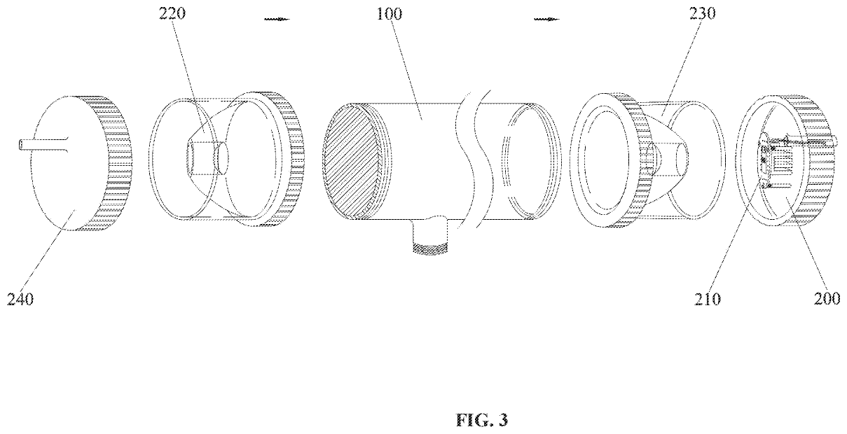

Embodiment 7, referring to FIG. 2 and FIG. 3, the UV modules 200 are arranged at a front end and a rear end of the reactor cavity 100, that is, two UV modules 200 are included, one is located on the front side of the reactor cavity 100, and the other one is located on the rear side of the reactor cavity 100. One UV module 200 serves as an expansion module. A uniform columnar collimating light source is projected by the radiation components 210 of the UV modules 200 at the two ends of the reactor cavity 100 after passing through the TIR lens 220.

In the present embodiment, optionally, a detachable structure is between the UV module 200 and the reactor cavity 100, which is used more flexibly. A connection manner between the UV modules 200 and the reactor cavity 100 includes, but is not limited to, mechanical bayonet fastening, thread screwing in, cementation, and hot-melt fastening.

In the present embodiment, optionally, the UV module 200 is in threaded connection with the reactor cavity 100.

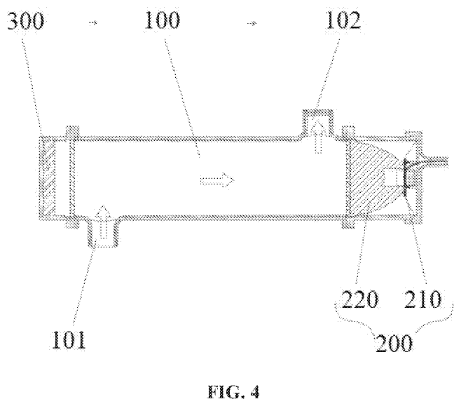

Embodiment 8, referring to FIG. 4, the UV module 200 is arranged at one end of the reactor cavity 100, and a reflection component 300 is arranged at the other end of the reactor cavity 100. The reflection component 300 serves as an expansion module. The reflection component 300 reflects or scatters the collimated light emitted from the UV modules 200 through a reflecting principle, so as to improve the utilization rate of the radiated UV light in the reactor cavity 100.

In the present embodiment, optionally, a reflection plate with high reflectivity is arranged in the reflection component 300. The material of the reflection plate with high reflectivity is aluminum, PTFE, etc.

In the present embodiment, optionally, a detachable structure is between the reactor cavity 100 and the UV modules 200 and between the reactor cavity 100 and the reflection component 300. Simple and convenient disassembly and replacement of the three modules of the reactor cavity 100, the UV modules 200, and the reflection component 300 significantly improves the flexibility of a disinfection reaction device and has more reliable practicability compared with the integration of a reaction cavity and a light source module in the traditional art. Connection manners between the reactor cavity 100 and the UV modules 200 and between the reactor cavity 100 and the reflection component 300 include, but are not limited to, mechanical bayonet fastening, thread screwing in, cementation, and hot-melt fastening.

In the present embodiment, optionally, the reactor cavity 100 is in threaded connection with the UV modules 200 and the reflection component 300.

Embodiment 9, a PTFE diffuse reflection coating is arranged on an inner wall of the reactor cavity 100 to serve as a Lambert diffuse reflective coating.

In the present embodiment, optionally, the reactor cavity 100 is directly made of a material reflecting UVC, such as the PTFE, or aluminum, or polished stainless steel, or may be made in a form of a supporting column-shaped cylinder.

In the present embodiment, optionally, the Lambert diffuse reflective coating covers an inner surface of the reactor cavity 100 by the methods, such as spray-coating and spray-plating.

Embodiment 10, the reactor cavity 100 is made in a 3D printing manner.

In the present embodiment, optionally, the material of the reactor cavity 100 is ceramics or zirconium oxide.

Embodiment 11, the reactor cavity 100 is made in a module pressing manner.

In the present embodiment, optionally, the material of the reactor cavity 100 is PTFE.

Embodiment 12, a quartz tube 110 is arranged in the reaction cavity 100, so as to improve the safety.

According to the abovementioned principle, the present disclosure can also make appropriate changes and modifications to the abovementioned embodiments. Therefore, the present disclosure is not limited to the specific implementation manner disclosed and described above, and some modifications and changes to the present disclosure should also fall within the scope of protection of the claims of the present disclosure.

In order to better demonstrate the effect of the present technology, fast model visualization of lighttools 8.7 optical software and illumination radiation analysis of a Monte Carlo technology are combined to truly simulate the effect of radiation light distribution and complete the evaluation of light field distribution.

Optical simulation parameters of the lighttools 8.7 are specifically set.

The reactor cavity 201 has the outside diameter of 16 mm, the inside diameter of 15.5 mm, and the length of 800 mm. The inner surfaces of optical properties of Cylindersurface, Rearsurface, and Frontsurface of the reactor cavity 201 are all set to have the reflectivity of 80%, the absorptivity of 20%, and Lambert scattering. The material is set to be silica.

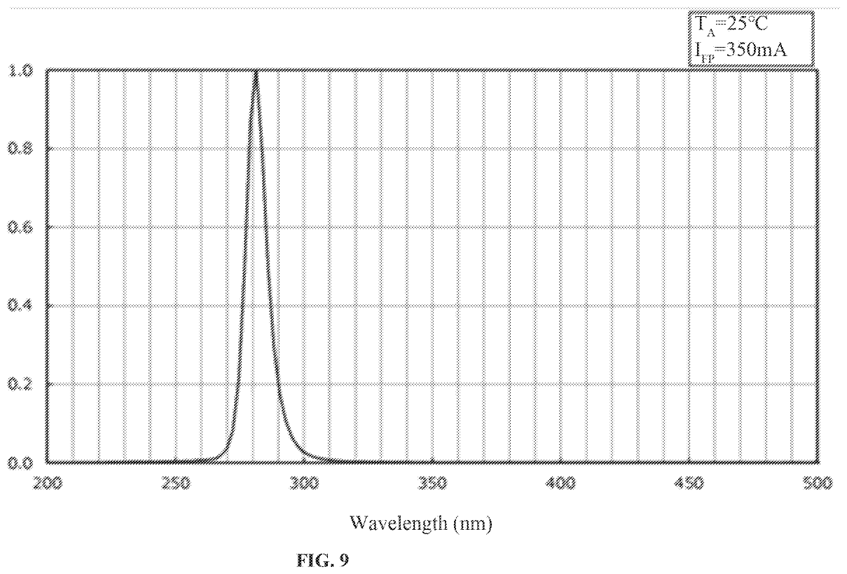

The deep UVC-LED of the UV module 200 adopts Nichia series NCSU334B, the radiation power is 0.07 W, the size is 6.8 mm*6.8 mm*2.12 mm, a light exit angle is 115°, and the peak wavelength of a spectral region is 280 nm. A spectrum diagram of a light source is as shown in FIG. 9.

The material of the TIR lens 220 of the UV module 200 is set be to silica. The known TIR lens combines large-angle condensing of a reflection cup and small-angle condensing of an inner lens to achieve a good collimating effect. Through Boolean cutting, software, and autonomous optimization, a user obtains the TIR lens with a total length of 15 mm and a radius of 12 mm

Specifically, the inner lens is formed by performing Boolean shear on a lens. The thickness of the lens is 5 mm. The LenRearsurface is a quadric surface. The inside diameter is 6 mm A curved surface coefficient and the radius are set as optimization variables to obtain convex surfaces of −0.35313 and 4.5000 respectively.

Specifically, the reflection cup is formed by performing shear on a lens. The lens has the thickness of 0.1 mm (it is mainly for shearing a blank of the TIR lens, so the thickness shall be as small as possible), the diameter is 26 mm, and the position is located 2 mm at a rear end of the deep UVC-LED chip; the shape of the LenRearsurface is a quadric surface; and the curved surface coefficient and radius are set as optimization variables to obtain convex surfaces of −1.1530 and 3.6550 respectively.

Specifically, the expansion module is arranged as a UV module 200.

In lighttools8.7, a plane receiving surface is established to obtain the irradiance of a cross section. A calculation result output form may be a two-dimensional line map, a contour map, a gray-scale map, a pseudo color map, or a three-dimensional distribution map. Specifically, the coordinate position of the deep UVC-LED chip of the UV module 200 is (0, 0, 0), the central coordinates of a light exit surface of the TIR lens are (0, 0, 15), and the total length of the reactor cavity 201 is 800 mm, the coordinate range of the reactor cavity 201 is (0, 0, 15) to (0, 0, 815), 19 receiving planes are set in total, and the radius size of the receiving plane is 20 mm

Through lighttools8.7 three-dimensional modeling set, the expansion module simulated this time adopts the UV module 200. However, the expansion module being the reflection component 300 should also be within the scope of protection of the present disclosure.

Simulation experiment results and analysis:

Through Illumination radiation analysis of a Monte Carlo technology, an element made of a material WATER is arranged in the reactor cavity, so that light propagates in an aqueous medium, the receiving plane has the mesh size of 150 partitions*150 partitions, is in an aperture mode. Through circular statistical analysis, the calculated radius size is 15 mm

It can be known from the light intensity distribution of each of the abovementioned related angle, after a single radiation source passes through the TIR lens, the light is gathered and distributed near 0°, so that the light exits very well in a collimation manner.

The analysis of the irradiance uniformity received by the receiving planes is generally calculated by using relative standard deviation

$$RSD = \frac{S}{X} \times 100 \% = \frac{\sqrt{\frac{{\sum }_{i = 1}^{N} {( x - {x}_{i} )}^{2}}{n - 1}}}{\overline{x}} \times 100 \%$$

In the formula, S corresponds to a standard deviation, x̅ is a corresponding average value, and a fluctuation situation of each surface can be obtained by comparing a relative standard deviation. The smaller the RSD is, the smaller and more uniform the fluctuation of the surface is.

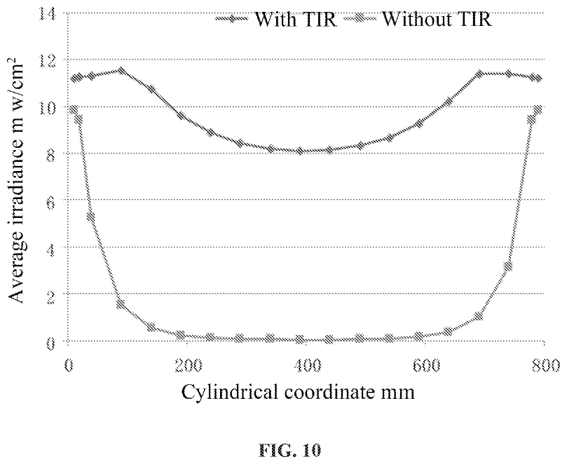

According to the analysis of the average irradiance diagram in FIG. 10, after the collimation of the TIR lens is added, the light is extends very well in a collimation manner. In the reactor cavity, the average irradiance without the TIR lens decreases sharply with the increase of the distance from the light source. After the addition of the TIR lens, the average irradiance will greatly reduce the energy lost with the increase of the distance from the light source, which makes maximum use of radiation energy in disinfection and purification of water.

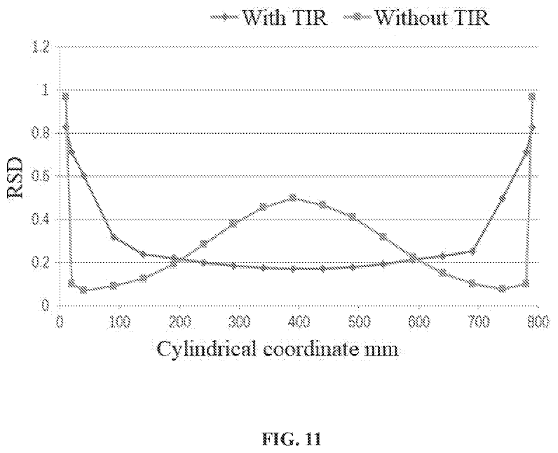

According to the analysis of an RSD diagram in FIG. 11, after the collimation of the TIR lens is added, the light extends in a collimation manner very well. In the reactor cavity, the RSD without the TIR lens increases with the increase of the distance from the light source, continuous increase of the RSD reflects continuous deterioration of the uniformity of each cross section of the overall reactor cavity. An initial value of the RSD added with the TIR lens is slightly larger, but the RSD decreases with the increase of the distance from the light source. The uniformity becomes better and tends to a stable value. It can be obtained from the drawing that the uniformity is good and the RSD changes slightly at 140 mm to 690 mm of the reactor cavity. Further, the overall good uniformity and higher irradiance can be obtained through the simulation of double radiation sources.

1. A collimation type disinfection and water purification device, comprising a reactor cavity, wherein the reactor cavity is a linear shape extending in a front side direction and a rear side direction; a water inlet and a water outlet are respectively formed in side walls of the front side and the rear side of the reactor cavity;
an ultraviolet (UV) module is arranged at an end part of the reactor cavity; the UV module comprises a radiation component and a Total Internal Reflection (TIR) lens; and
the light emitted from the radiation component is projected as a uniform columnar collimating light source after passing through the TIR lens.

2. The collimation type disinfection and water purification device according to claim 1, wherein the radiation component comprises a deep UVC-LED with the wave band of 200 to 320 nm.

3. The collimation type disinfection and water purification device according to claim 1, wherein the UV module comprises a UV module sleeve and a substrate.

4. The collimation type disinfection and water purification device according to claim 3, wherein a mounting groove is formed in the substrate.

5. The collimation type disinfection and water purification device according to claim 3, wherein the radiation component comprises a radiation source substrate and radiating fins;
a radiating fin alignment groove (242) is formed in the mounting groove; the mounting groove corresponds to the radiation source substrate; and the radiating fin alignment groove corresponds to the radiating fins.

6. The collimation type disinfection and water purification device according to claim 4, wherein auxiliary radiating fins are arranged on the substrate.

7. The collimation type disinfection and water purification device according to claim 1, wherein the UV modules are arranged at a front end and a rear end of the reactor cavity.

8. The collimation type disinfection and water purification device according to claim 1, wherein the UV module is arranged at one end of the reactor cavity, and a reflection component is arranged at the other end of the reactor cavity.

9. The collimation type disinfection and water purification device according to claim 1, wherein a Polytetrafluoroethylene (PTFE) diffuse reflection coating is arranged on an inner wall of the reactor cavity.

10. The collimation type disinfection and water purification device according to claim 1, wherein a quartz tube is arranged in the reactor cavity.
